(19) United States
(12) Patent Application Publication
(10) Pub. No.: US 2010/0169246 A1
(43) Pub. Date: Jul. 1, 2010

(54) Multimodal system and input process method thereof

(75) Inventors: Jun Won Jang, Yongin-si (KR); Tae Sin Ha, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon (KR)

(21) Appl. No.: 12/591,832

(22) Filed: Dec. 2, 2009

(30) Foreign Application Priority Data
Dec. 30, 2008 (KR) 10-2008-0136179

(51) Int. Cl. G06F 15/18; G10L 15/00; G05B 11/01

(52) U.S. Cl. 706/12; 704/275; 700/11; 704/E15.001

(57) ABSTRACT

A multimodal system and an input processing method thereof are disclosed. The multimodal system includes a pre-constructed input combination constructing unit and an input combination selection unit for selecting an input combination corresponding to an input signal from a user or a sensor. The system performs learning for selecting an input combination from the pre-constructed input combinations. The system provides available input combinations due to this learning, resulting in high satisfaction with the processed result.

### CROSS-REFERENCE TO RELATED APPLICATIONS

This application claims the benefit of Korean Patent Application No. 2008-0136179, filed on Dec. 30, 2008 in the Korean Intellectual Property Office, the disclosure of which is incorporated herein by reference.

### BACKGROUND

1. Field

One or more embodiments relate to a multimodal system and an input processing method thereof, and more particularly to a multimodal system for carrying out given tasks according to an input signal from a user or sensor, and an input processing method of the multimodal system.

2. Description of the Related Art

A multimodal system has been introduced to various fields (e.g., a humanoid robot, a home automation, and a building automation) for intelligently processing various complicated tasks having different characteristics.

For example, in order to implement the humanoid robot, a function for carrying out various actions (e.g., a walking, manipulation, and motion) and another function for implementing intelligence by which the robot can think and judge like a human being are of importance.

The multimodal system performs a series of decisions and actions to complete a given objective. For this objective, there is a need for the multimodal system to learn and process proper knowledge. Knowledge base technologies based on the knowledge related to the execution of tasks are used to learn and process the above knowledge. In this case, the multimodal system is not based on only a single input signal, and the single input signal or various input signals are synthetically understood, inferred and processed.

A representative example of input processing methods for use in the multimodal system makes a combination of input signals received from the user and various sensors, and uses this combination of input signals.

After input signals from the user and various sensors occur in the conventional multimodal system, the combination of input signals is configured, and this combination is then processed. Since inference of this processing method is correct under only extremely-limited situations and conditions, user recognition of the processed result will also be limited, thereby leading to low user satisfaction.

### SUMMARY

Therefore, it is an aspect of one or more embodiments to provide a multimodal system for providing effective input combinations, and an input processing method thereof.

It is an aspect of one or more embodiments to provide a multimodal system for increasing a sense of satisfaction using a predesigned input combination, and an input processing method thereof.

Additional aspects and/or advantages will be set forth in part in the description which follows and, in part, will be obvious from the description, or may be learned by practice of one or more embodiments.

In accordance with one or more embodiments, there is provided a multimodal system including a multimodal input unit providing at least one input signal, an input combination constructing unit in which at least one input combination for executing a certain action corresponding to the at least one input signal is pre-constructed, and an input combination selection unit for selecting a final input combination according to the at least one input signal.

The multimodal input unit may provide a voice signal or a sensor's input signal.

The input combination selection unit may select one of the at least one input combination from the input combination constructing unit.

The input combination selection unit may select the final input combination using only the at least one input signal provided from the multimodal input unit.

The input combination constructing unit may include an input combination selected by a user.

The input combination constructing unit may perform learning from a first input combination which has been initially selected at random, such that input combinations of the at least one input combination are selected according to the learned result.

The input combination constructing unit may perform learning from a first input combination which has been initially selected by a user, such that input combinations of the at least one input combination are selected according to the learned result.

The learning may be used to select the input combinations of the at least one input combination such that user satisfaction of a result processed by a previous input combination becomes higher.

The learning may correspond to any one of a process for removing an input combination, a process for generating an input combination, a process for dividing an input combination, a process for merging an input combination, and a process for improving an input combination.

In accordance with another aspect of one or more embodiments, there is provided an input processing method for a multimodal system including pre-constructing at least one input combination for executing a certain action, selecting an input combination according to an input signal provided from a user or a sensor, and executing an action corresponding to the selected input combination.

The selecting may select any one of the at least one input combination of the pre-constructed input combinations.

The selecting may select any one of the at least one input combination using only the input signal provided from the user or the sensor.

The pre-constructing of the at least one input combination may include an input combination selected by the user.

The pre-constructing of the at least one input combination may include an input combination selected by performing learning from a first input combination which has been initially selected at random.

The pre-constructing of the at least one input combination may include an input combination selected by performing learning from a first input combination which has been initially selected by the user.

The learning may correspond to any one of a process for removing an input combination, a process for generating an input combination, a process for dividing an input combination, a process for merging an input combination, and a process for improving an input combination.

### BRIEF DESCRIPTION OF THE DRAWINGS

These and/or other aspects and advantages of the invention will become apparent and more readily appreciated from the following description of one or more embodiments, taken in conjunction with the accompanying drawings of which:

FIG. 1 illustrates a block diagram of a multimodal system according to one or more embodiments;

FIG. 2A illustrates a conceptual diagram of an input combination constructing unit according to an embodiment;

FIG. 2B illustrates a conceptual diagram of an input combination constructing unit according to another embodiment;

FIG. 2C illustrates a conceptual diagram of an input combination constructing unit according to still another embodiment;

FIG. 3 is a table for explaining symbols and actions corresponding to input combinations according to one or more embodiments;

FIG. 4 illustrates a flow chart of an input processing method for a multimodal system according to one or more embodiments; and

FIG. 5 illustrates a conceptual diagram of a method for performing operations of an air-conditioner according to an input processing method of the multimodal system of FIG. 4.

### DETAILED DESCRIPTION

Reference will now be made in detail to one or more embodiments, examples of which are illustrated in the accompanying drawings, wherein like reference numerals refer to like elements throughout. The embodiments are described below to explain the disclosure by referring to the figures.

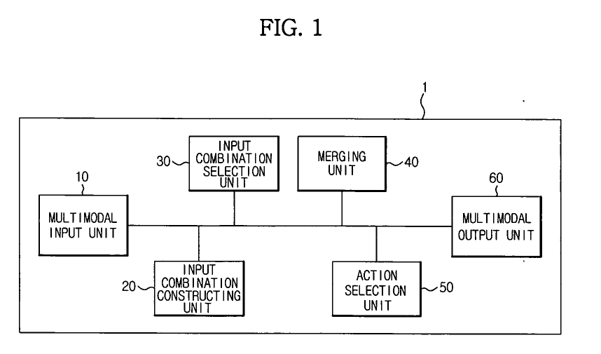

Referring to FIG. 1, a multimodal system 1 according to one embodiment includes a multimodal input unit 10, an input combination constructing unit 20, an input combination selection unit 30, a merging unit 40, an action selection unit 50, and a multimodal output unit 60.

The multimodal input unit 10 receives various input signals from a user or a sensor. The input signals entered by the user are voice signals of the user, and may also be other input signals entered by the user. In this case, the multimodal input unit 10 includes a voice recognition engine for analyzing the user's voice signals and recognizing them.

The input combination selection unit 30, the input combination constructing unit 20, the merging unit 40, and the action selection unit 50 perform a series of processes. According to the processed result, the multimodal output unit 60 outputs a voice or execution command to the user or object to be controlled.

The multimodal system according to one or more embodiments receives various input signals from the user or sensor, and provides the user or control object with the processing result responding to the above input signals. A method for constructing the input combination and a method for selecting an input combination among input combinations until the multimodal system completes a given task greatly affect the degree of satisfaction with the processed result. In other words, the multimodal system intelligently processes various complicated and characteristic tasks. The multimodal system must select an appropriate input combination according to the multimodal input signal, such that the processed result becomes satisfactory.

The input combination constructing unit 20 pre-constructs input combinations having availability. A variety of embodiments related to the construction of such input combinations will hereinafter be described. In this case, the input combination is composed of at least one input signal provided from the user or sensor.

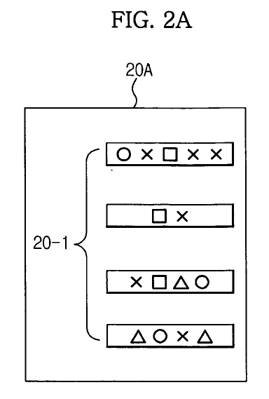

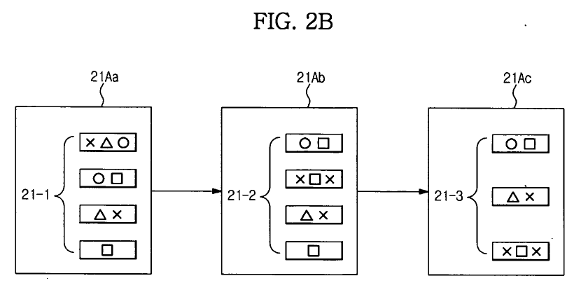

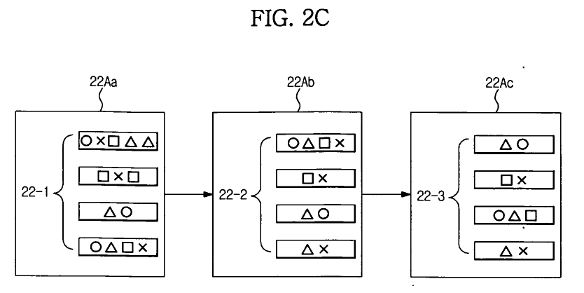

Referring to FIG. 2A, a first input combination constructing unit 20A includes an input combination set 20-1 constructed by the user.

Input combinations contained in the input combination set 20-1 are directly selected by the user in consideration of the user's experience or the use environment, and the selected input combinations are grouped in one. If the input combinations contained in the set 20-1 are selected, the processed result is well matched with the user's intention.

A method for constructing an input combination according to another embodiment will hereinafter be described with reference to FIG. 2B.

The second input combination constructing unit 21Aa is self-made by the multimodal system 1. The second input combination constructing unit 21Aa includes an initially-constructed input combination set 21-1. Input combinations contained in the input combination set 21-1 are randomly selected from among generally-expected input candidates, such that the input combinations are composed of the selected input candidates.

Then, the multimodal system learns the processed result, such that it changes the initially-constructed input combination 21-1 to another input combination set 21-2. The changed input combination set 21-2 includes other input combinations which did not exist in those of the first input combination 21-1, and does not include the initially-existing input combinations which existed in the first input combination 21-1. Another input combination set 21-3 has no new input combinations due to the use of the multimodal system, whereas it does not have any one of the initially-existing input combinations.

After the system firstly makes the input combinations at random, this system learns the processed result such that it makes second input combination constructing units 21Ab and 21Ac. In this way, if the input combinations are constructed, an input combination having a good processed result remains, and another input combination having a bad processed result is excluded from the constructed input combinations. If the system selects input combinations contained in the changed input combination sets 21-2 and 21-3 according to the learned result, the processed result has higher satisfaction.

A method for constructing input combinations according to still another embodiment shown in FIG. 2C are partially similar to those of the above-mentioned embodiments.

A third input combination constructing unit 22Aa includes an input combination set 22-1 constructed by the user. Input combinations contained in the input combination set 22-1 are directly selected by the user in consideration of the user's experience or use environment.

Then, the multimodal system learns the processed result, such that it changes the initially-constructed input combination 22-1 to another input combination set 22-2 and makes a third input combination constructing unit 22Ab. The changed input combination set 22-2 includes other input combinations which did not exist in those of the first input combination 22-1, and does not include the initially-existing input combinations which existed in the first input combination 22-1. Another third input combination constructing unit 22Ac including input combination set 22-3 has no new input combinations due to the use of the multimodal system, whereas it does not have any one of the initially-existing input combinations. By this learning result, the input combinations pre-constructed by the user are changed to others. If input combinations contained in the changed input combination set are selected, the processed result has higher satisfaction.

Although a method for changing the input combination set according to the learning result has not been disclosed in the above-mentioned embodiments, this changing method may include a method for removing input combinations, generating new input combinations, dividing input combinations, merging input combinations, and improving input combinations,

The input combination constructing unit 20 (FIG. 1) may be constructed using any one input combination constructing unit among the first to third input combination constructing units in consideration of a system use environment.

Referring back to FIG. 1, the input combination selection unit 30 receives at least one input signal from the multimodal input unit 10, and selects an input combination appropriate for the received input signal from the input combination constructing unit 20. In this case, although the selection of such input combination is firstly performed in proportion to the satisfaction of the pre-processed result, the scope or spirit of one or more embodiments is not limited to this example, and a reference for this selection may be pre-determined such that the input combination constructed in the input combination constructing unit 20 may be selected. For example, if the input combination constructing unit 20 is unable to select an appropriate input combination using currently-received input signals (for example, if the input combination constructing unit 30 receives only one input signal), the input combination selection unit 30 selects desired input combinations using only the current input signals. In other words, the input combination selection unit 30 may select another input combination not contained in the input combination constructing unit 20.

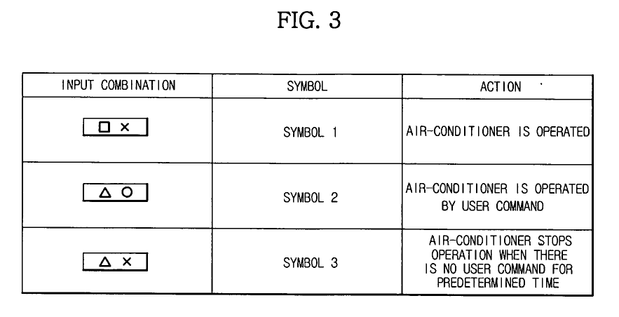

The merging unit 40 receives input combinations selected by the input combination constructing unit 20, merges individual input signals constructing the input combinations, recognizes a symbol for their execution, and provides the action selection unit 50 with the recognized symbol. The action selection unit 50 transmits a command for executing the action corresponding to the recognized symbol to the multimodal output unit 60. In this case, the merging unit 40 and the action selection unit 50 store input combinations, symbols, actions, and their relationship information as shown in FIG. 3.

Upon receiving a command for executing the action corresponding to the symbol, the multimodal output unit 60 may output voice signals or drive an object to be controlled.

For example, if a specific task for operating an air-conditioner driven by either the user's voice signal or the environment recognition result is assigned to the multimodal system, an input combination is selected according to an input signal received from the user or the sensor, a symbol corresponding to the selected input combination is decided, and an action corresponding to the decided symbol is executed. For example, referring to FIG. 3, if a second symbol (Symbol 2) of FIG. 2 is decided, the air-conditioner can be operated upon receiving a command from the user. If there is no command from the user, the air-conditioner is not operated.

A method for processing input signals of the multimodal system according to one or more embodiments will hereinafter be described.

The multimodal system according to one or more embodiments can be applied to a humanoid robot, a home automation, a building automation and the like. An example in which the task for operating the air-conditioner is assigned to the system will hereinafter be described.

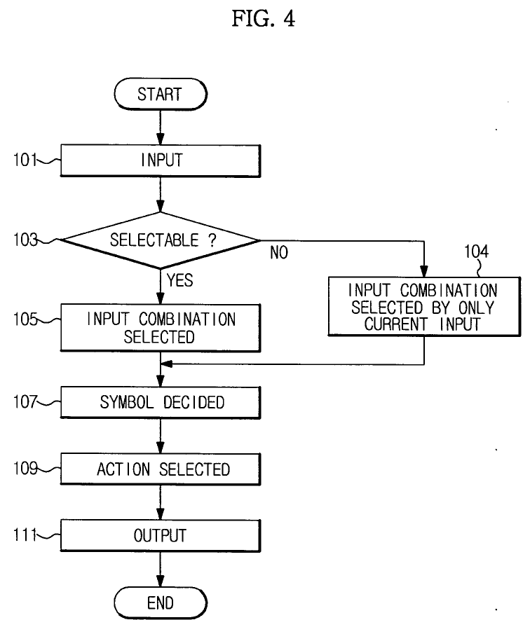

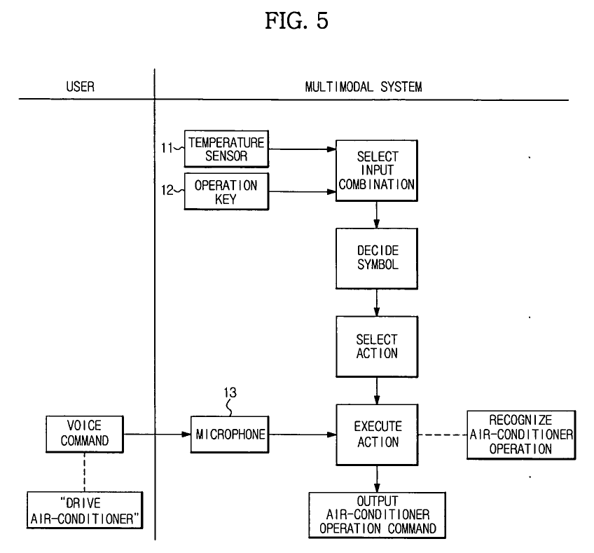

Referring to FIGS. 1, 4, and 5, the input unit 10 includes a temperature sensor 11 for environment recognition, an operation key 12, a microphone 13 and the like.

If at least one of multimodal input signals (e.g., a temperature measured by the temperature sensor 11, an operation command of the operation key 12, and a voice signal measured by the microphone 13) occurs, the input unit 10 provides this input signal to the input combination selection unit 20 at operation 101.

If the input combination selection unit 30 receives at least one input signal, it selects any one of input combinations from the input combination constructing unit 20 at operations 101 and 105. At operation 103, it is determined whether a desired input combination can be selected from the provided input signals. If a desired input combination cannot be selected from the provided input signals, the input combination selection unit 30 selects an input combination using only the current input signals at operation 104.

If the input combination can be selected, in operation 105, the input combination is selected, and the input combination selection unit 30 provides the merging unit 40 with the selected input combination. The merging unit 40 merges input signals belonging to the selected input combination, such that it decides a symbol corresponding to the merged result at operation 107. In this case, the symbol decision may use correlation information shown in FIG. 3.

In operation 109, the action selection unit 50 transmits a command for executing a specific action appropriate for the decided symbol to the multimodal output unit 60. Therefore, the multimodal output unit 60 operates the air-conditioner in operation 111. For example, if the second symbol (Symbol 2) is decided as shown in FIG. 3, the action selection unit 50 can provide the multimodal output unit 60 with an operation command of the air-conditioner only when it receives a command from the user. If there is no command from the user, the operation command is not provided to the multimodal output unit 60.

As is apparent from the above description, one or more embodiments pre-construct any available input combinations, and properly select necessary input combinations according to an input signal provided from the user or the sensor, resulting in implementation of user's high satisfaction.

In addition to the above described embodiments, example embodiments can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media. The media may also be a distributed network, so that the computer readable code is stored/transferred and executed in a distributed fashion. Still further, as only an example, the processing element could include a processor or a computer processor, and processing elements may be distributed and/or included in a single device.

In addition to the above described embodiments, example embodiments can also be implemented as hardware, e.g., at least one hardware based processing unit including at least one processor capable of implementing any above described embodiment.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A multimodal system comprising:
a multimodal input unit providing at least one input signal;
an input combination constructing unit in which at least one input combination for executing a certain action corresponding to the at least one input signal is pre-constructed; and
an input combination selection unit for selecting a final input combination according to the at least one input signal.

2. The multimodal system according to claim 1, wherein the multimodal input unit provides a voice signal or a sensor's input signal.

3. The multimodal system according to claim 1, wherein the input combination selection unit selects one of the at least one input combination from the input combination constructing unit.

4. The multimodal system according to claim 3, wherein the input combination selection unit selects the final input combination using only the at least one input signal provided from the multimodal input unit.

5. The multimodal system according to claim 1, wherein the input combination constructing unit includes an input combination selected by a user.

6. The multimodal system according to claim 1, wherein the input combination constructing unit performs learning from a first input combination which has been initially selected at random, such that input combinations of the at least one input combination are selected according to the learned result.

7. The multimodal system according to claim 1, wherein the input combination constructing unit performs learning from a first input combination which has been initially selected by a user, such that input combinations of the at least one input combination are selected according to the learned result.

8. The multimodal system according to claim 6, wherein the learning is used to select the input combinations of the at least one input combination such that user satisfaction of a result processed by a previous input combination becomes higher.

9. The multimodal system according to claim 7, wherein the learning is used to select the input combinations of the at least one input combination such that user satisfaction of a result processed by a previous input combination becomes higher.

10. The multimodal system according to claim 6, wherein the learning corresponds to any one of a process for removing an input combination, a process for generating an input combination, a process for dividing an input combination, a process for merging an input combination, and a process for improving an input combination.

11. The multimodal system according to claim 7, wherein the learning corresponds to any one of a process for removing an input combination, a process for generating an input combination, a process for dividing an input combination, a process for merging an input combination, and a process for improving an input combination.

12. An input processing method for a multimodal system comprising:
pre-constructing at least one input combination for executing a certain action;
selecting an input combination according to an input signal provided from a user or a sensor; and
executing an action corresponding to the selected input combination.

13. The method according to claim 12, where the selecting selects any one of the at least one input combination of the pre-constructed input combinations.

14. The method according to claim 12, wherein the selecting selects any one of the at least one input combination using only the input signal provided from the user or the sensor.

15. The method according to claim 12, wherein the pre-constructing of the at least one input combination includes an input combination selected by the user.

16. The method according to claim 12, wherein the pre-constructing of the at least one input combination includes an input combination selected by performing learning from a first input combination which has been initially selected at random.

17. The method according to claim 12, wherein the pre-constructing of the at least one input combination includes an input combination selected by performing learning from a first input combination which has been initially selected by the user.

18. The method according to claim 16, wherein the learning corresponds to any one of a process for removing an input combination, a process for generating an input combination, a process for dividing an input combination, a process for merging an input combination, and a process for improving an input combination.

19. The method according to claim 17, wherein the learning corresponds to any one of a process for removing an input combination, a process for generating an input combination, a process for dividing an input combination, a process for merging an input combination, and a process for improving an input combination.
